(19) United States
(12) Patent Application Publication
(10) Pub. No.: US 2019/0188752 A1
(43) Pub. Date: Jun. 20, 2019

(54) SYSTEM AND METHOD FOR EXPERIENTIAL MARKETING

(71) Applicant: PAIRR Technology, LLC, Dallas, TX (US)

(72) Inventor: Zachary Jones, Dallas, TX (US)

(21) Appl. No.: 16/221,405

(22) Filed: Dec. 14, 2018

Related U.S. Application Data
(60) Provisional application No. 62/598,898, filed on Dec. 14, 2017.

(51) Int. Cl. G06Q 30/02

(52) U.S. Cl. CPC G06Q 30/0245; G06Q 30/0255; G06Q 30/0258; G06Q 30/0244

(57) ABSTRACT

The present disclosure relates to systems and methods for experiential marketing, and more particularly, to experiential marketing that customizes experiences and events based on the specific preferences of selected consumers, comprising registering one or more consumers with an experiential marketing platform; collecting data of the one or more consumers identifying a targeted subset of the one or more consumers based on the data; identifying one or more preferred experiences of the targeted subset; and hosting an experiential marketing event relating to the one or more preferred experiences for the targeted subset.

### CROSS-REFERENCE TO RELATED APPLICATION

This application claims priority to U.S. Provisional Patent Application No. 62/598,898, entitled “SYSTEM AND METHOD FOR IMPROVING EXPERIENTIAL MARKETING” filed on Dec. 14, 2017.

### SUMMARY

The present disclosure relates to systems and methods for improving experiential marketing. More particularly, the present disclosure relates to experiential marketing that customizes consumer experiences and events based on the specific preferences of selected consumers.

The present disclosure relates to systems and methods for an experiential marketing platform whereby customized events and experiential marketing campaigns are created for a subset of individuals that have opted-in to the experiential marketing platform and have been invited to attend the event or experiential marketing campaign by the event organizer or brand through the experiential marketing platform.

The method may comprise the steps of one or more individuals (“consumers”) opting-in to the experiential marketing platform through a registration interface; consumers authorizing and directing the experiential marketing platform to collect digital information on the consumer via integrations with social networks (for example, Facebook, Instagram, Pinterest, Linkedin, Twitter) and electronic personal data aggregation services (for example, Experian, LexisNexis, Full Contact) through an integration selection interface; consumers selecting demographic information representative of their personal demographic category through a demographic interface; consumers selecting their “experience elements” through the consumer experience element selection interface; the experiential marketing platform storing the consumers information and selections in an electronic data base; the experiential marketing platform making the aggregated information and selections available for anonymous view and manipulation by client interfaces; client manipulating the information to create subsets of desired consumers through a personal interface; experiential marketing platform providing a ranking of experience elements for client's selected subset through the client experience element interface; client utilizing the experience element interface to determine and create events for the selected subset that incorporate the selected experience elements; client utilizing the invitation interface to notify the selected consumers of their selection to attend client's event; client producing an event whereby access is limited to the selected consumers; consumers attending the event and gaining access through the experiential marketing platform's invitation interface; client utilizing the task interface to send messages to attending consumers' mobile devices before, during and after the event, describing specific content for the consumer to capture with their mobile device and directing the consumer to post the content on desired social media networks; the experiential marketing platform tracking consumer compliance with the client's tasks via the social network integrations selected by consumer; the experiential marketing platform tracking views and actions taken with respect to the consumer's posts on social media via the social network integrations selected by consumer; client viewing consumer task compliance and post views through the social impressions interface; the experiential marketing platform associating consumer task compliance and post views and actions with the relevant consumer in the electronic database; the client having access to attendance, task compliance and reach information for selection of consumers for future events.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1 illustrates a system overview of an improved experiential marketing system according to the present disclosure; and

FIG. 2 illustrates a flow diagram of a preferred method of improving experiential marketing according to the present disclosure.

Like reference symbols in the various drawings indicate like elements.

### DETAILED DESCRIPTION

### Experiential Marketing System Overview

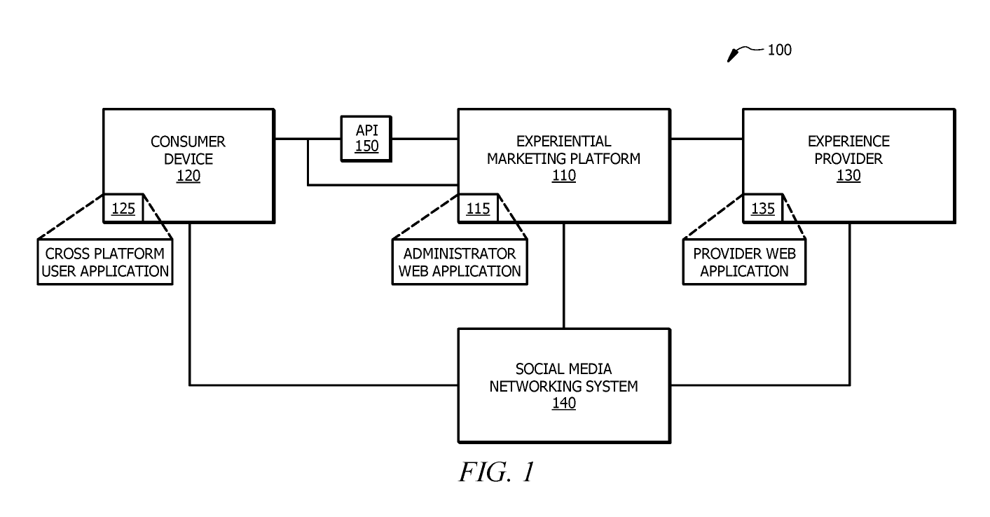

FIG. 1 depicts a system overview of an implementation of an improved experiential marketing system 100 according to the present disclosure. Improved experiential marketing system 100 comprises an experiential marketing platform 110, a consumer device 120, an experience provider 130 (i.e., the event producer, brand or marketing agency providing experiences to promote its consumer goods or services and also referred to throughout this disclosure as “client” or “brand”), a social media networking system 140, and an application programming interface (“API”) 150. For purposes of illustration, the embodiment of the system 100 shown by FIG. 1 includes a single consumer device 120, a single 130, a single social media networking system 140, and a single API 150. However, in other implementations, the system 100 may include one or more consumer devices, one or more client interfaces, one or more social media networking systems, and/or one or more APIs.

With further reference to FIG. 1, consumer device 120 may comprise a desktop computer, a laptop computer, a mobile device such as a smart phone or tablet, or any other device having computing functionality and data communication capabilities. Consumer device 120 and experience provider 130 may be configured to communicate with experiential marketing platform 110 and social media networking system 140 via a network (not shown). The network may comprise any combination of local area and/or wide area networks, using wired and/or wireless communication systems.

According to an implementation, when a consumer communicates with the experiential marketing platform 110, the consumer may have the option of downloading a cross-platform user application 125 (e.g., a mobile or web application) onto his/her consumer device 120. The cross-platform user application 125 enables communication and data transmission between consumer device 120 and the experiential marketing platform 110 and may include different functionalities, as described in more detail herein.

With continued reference to FIG. 1, experience provider 130 is configured to communicate with experiential marketing platform 110 via a provider web application 135, which may include various dashboard and reporting functionalities, as described in more detail herein.

With further reference to FIG. 1, experiential marketing platform 110 may include a downloadable administrator web application 115 through which the experiential marketing platform may manage the experiential marketing system. The administrator web application 115 may include many different functionalities, as described in more detail herein.

### Experiential Marketing Method

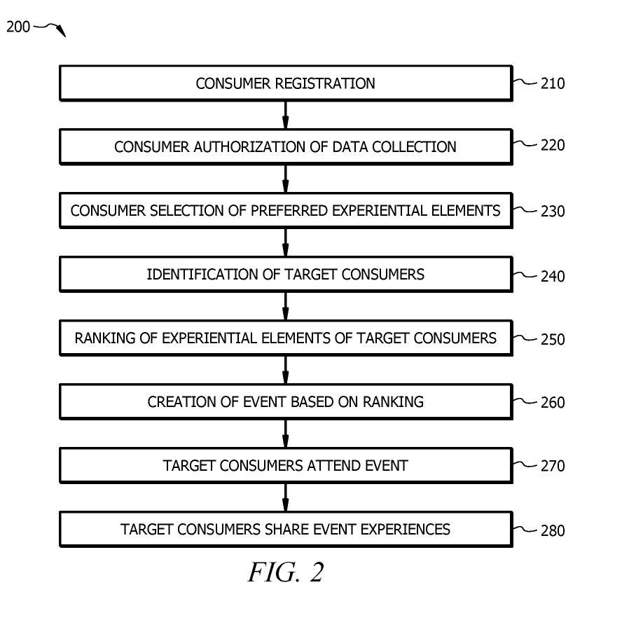

Reference is now made to FIG. 2 wherein is depicted a flow diagram 200 of a preferred method of improving experiential marketing according to the present disclosure. At step 210, one or more consumers may opt-in to the experiential marketing platform and register a consumer account. A consumer may choose to register and log in to the experiential marketing platform using an existing social media account (or other such account) via an associated social media API (or other API). For example, a consumer with a Facebook account may sign-up and log in to the experiential marketing platform using, for example, a Facebook API. By integrating consumer registration and log-in with a consumer's existing social media account, the experiential marketing platform may access various consumer information available through the integrated social media account. Additionally, multiple social media accounts may be integrated with the consumer account. For example, a consumer may link his Facebook, Twitter, Instagram, Pinterest, LinkedIn, Google Plus, and/or other social media accounts with his experiential marketing account. A consumer may also integrate non-social media accounts (e.g., Lexis, Experian, etc.) with his experiential marketing account as well. Alternatively, the consumer may also register and log in to the experiential marketing platform without an existing social media or similar account by using an email address.

At step 220, the consumer may authorize and direct the experiential marketing platform to access and collect his/her data based on information that is transmitted, received, shared, posted, or otherwise disseminated from/on the consumer's integrated social media account(s). Collected consumer data may include, but is not limited to, information relating to demographics, income, occupation, and/or interests relating to travel, sports, food, music, etc., and/or other data commonly collected by social media and personal data collection companies. All collected consumer data may be stored in a database associated with the experiential maketing platform and may be used by the experiential marketing platform to enhance the experiential marketing system. Data-collection API (Application Programing Interface) technologies are known in the art, and the present disclosure is not to be construed as limited to any particular data-collection or mining technology.

At step 230, the consumer may view and select his/her preferred experiential elements, which are depcitions of activities and events that the consumer would like to be included in the events tailored for the consumer. The experience elements consist of digital pictures with descriptive copy and arranged on the screen of a digital device. The consumer may also select additional experience and event preferences from a multi-tiered list of experiential elements generated by the experiential marketing platform. Categories of the multi-tiered experiential elements may include activities, hobbies, interests, foods, locations, and a host of other experiential preferences selectable by the consumer. By way of example, a first tier of experiential elements may include general categories of interest, such as food, sports, music, etc. A consumer selecting “food” from the first tier may then access and select from a second tier of subcategories relating to “food”. These may include, for example, “pizza”, “sushi”, “burgers”, etc. Selection of experiential elements serve as data points associated with consumers in the the experiential marketing platform database, and then viewed and manipulated by event producers and brands to create events for consumers.

At step 240, client may filter and select target consumers based on one or more preferred experiential elements, consumer attributes, or other preferred metrics determined by the client. For example, beginning with a complete list of all consumers registered with the experiential marketing platform, the client may apply one or more filters to reduce the list to a set of target consumers. Filters may be based on any number of parameters, including but not limited to age, gender, income, social media activity level, marital status, hobbies, interests, etc.

In another implementation, the client may apply a given set of filters to the complete list of consumers to create a “persona”, i.e., a consumer list filtered by specific parameters which may be stored by the client. By way of example, the client desiring target consumers who are married males, are over the age of 40, and have an income over $100,000, may apply the appropriate filters based on marital status, gender, age, and income. The client may name and store this persona as “Mr. Mom” (for example) for present or future use.

At step 250, the experiential marketing platform may rank the experiential elements of the selected target consumers to enable the client to discover convergent experiential elements. In another implementation, the client may select one or more personas and the experiential marketing platform may rank the experiential elements associated with the selected personas to enable the client to discover convergent experiential elements. For example, the system may calculate percentages of the target consumers who selected each category or sub-category of experiential elements. This enables the client to determine the most popular experiences that are most likely to be attended by the most desirable consumers, and allows client to expand resources only producing those type of experiences.

At step 260, based on the rankings provided by the experiential marketing platform, the client may create one or more live events that the selected target consumers are likely to attend and enjoy. The experiential marketing platform may send live event invitations to the selected target consumers (or alternatively, to consumers in one or more selected personas). Invitations to a live event may be electronically transmitted via, for example, the cross-platform user application downloaded on each consumer's device. Alternatively, the experiential marketing platform may send invitations to an event via e-mail, social media, or other means known in the art.

The client may designate the number of target consumers that each live event may accommodate (i.e., the threshold number of attendees that may attend the event). The client may also designate whether target consumers may bring zero or more guests to the live event. Target consumers who are interested in attending the live event (“attending target consumers”) may so notify the experiential marketing platform by push notification or any other electronic means known in the art. The experiential marketing platform may track the number of attending target consumers and guests, where applicable. Once the threshold number of attendees has been reached for the event, the experiential marketing platform may close the event, preventing additional target consumers from accepting the invitation.

The experiential marketing platform may provide attending target consumers with a unique electronic “ticket” or barcode which will enable them to enter and attend the live event. Attending target consumers may also be provided with additional information relating to the event, e.g., location, maps, reminders, alerts, etc. Guests of attending target consumers who are not registered users of the experiential marketing platform may be required to register with the experiential marketing platform in order to attend the live event. Once registered, guests will also be provided with an electronic ticket or barcode which will enable access to the live event, as well as location information, maps, alerts, etc. relating to the live event.

At step 270, attending target consumers and their guests may attend the live event created by the client. Attending target consumers and their guest will gain access to the live event via the electronic ticket or barcode that was sent to them by the experiential marketing platform. Because the attending target consumers were filtered and selected based on their interests, the client is able to tailor the event to the interests/preferences of these target consumers.

At step 280, the attending target consumers and their guests may take pictures and videos and share their live event experiences on one or more social media sites, thereby furthering the reach of the brand/client and experiential event with the same level of reach of digital push marketing. The experiential marketing platform may also request attending target consumers to complete post-event tasks, such as sharing pictures relating to the event on social media, and may provide the consumers with incentives for such social media sharing.

The experiential marketing platform may compile statistics and create reports for clients relating to consumer patterns, attendance, social media use, etc. This information may be used by clients to further tailor live events to the specific desires and trends of consumers.

### Example Cross-Platform User Application Functionalities

Referring again to FIG. 1, as previously described, when a user registers with the experiential marketing platform 100, the user may download a cross-platform user application 125 to his/her consumer device 120 to enable communication and data transmission between consumer device 120 and the experiential marketing platform 110.

The cross-platform user application 125 may have many different functionalities, including one or more of the following:
A “user/login registration view state” allows consumers to register and/or login to the experiential marketing platform using one or more existing social media accounts. Additional features of the “user/login registration view state” may include password recognition, location preferences, login and/or “forgot password” wizard, reconciliation of multiple accounts, foreground location services, and/or backup manual location selection wizard.
A “user interests explorer view state” allows a consumer to dynamically explore and select and/or deselect experiential elements, i.e., activities, interests, hobbies, and other preferred experiences of the consumer. The experiential marketing platform 110 may also suggest experiential elements based on experiential elements selected by the consumer.
A “user brand explorer view state” provides a dynamic listing of clients (i.e., brands) selected by the experiential marketing platform 110 based on experiential elements selected by the consumer. The “user brand explorer view state” allows consumers to request an invite from a brand, request an event status, request a brand profile, request a listing of brand-hosted events, etc.
A “user event explorer view state” allows a consumer to access a dynamic listing of events in the system based on experiential elements selected by the consumer and brands associated with the consumer. This view state also allows a consumer to accept an event invite, remove acceptance of an invite, and manage other event actions.
A “user event profile view state” provides details of each event listing, including the event “story” (i.e., the brand message to be communicated by the event), related events hosted by the same brand, event venue, event time, and event date. This view state further offers display of attendance (showing a listing of all consumers attending an event), preloaded pictures/images provided by the brand, post-event pictures, and rewards listings available to consumers attending the event.
A “user calendar view state” displays event listings per date in a calendar format. This view state allows the consumer to search within calendar dates, view his/her own calendar as well as the calendars of brands he/she has access to, and integrate selected events into his/her own phone calendar.
A “user navigation view state” is a left or right pull-over menu listing profile pages, subprofile pages, and gamification view states.
A “user sub-pages view state” allows a consumer to dictate the types and frequency of email and push messages that will be received from the experiential marketing platform 110.
A “user profile view state” allows the consumer to share his/her story (which may optionally be pulled in from the consumer's associated social account(s)), display the events selected by the consumer, and upload pictures. The function also allows for gamification management and general profile management actions (i.e., adding/deleting pictures, interests, etc.)
A “user gamification view state” displays triggers and awards received by the consumer from the experiential marketing platform, categorized by levels and badges displayed on the consumer profile and sharable on social media platforms.
An “application configuration and services” function integrates an API framework (which allows the consumer's information to be pulled into the application, and provides details regarding the specific and version and type of device used by the consumer), integrates social media share and display functions, and integrates background location services (which allows notifications to the consumer when he/she comes within a certain radius of an event).

### Example Experiential Marketing Platform Functionalities

Referring again to FIG. 1, as previously described, the experiential marketing platform 110 may include a downloadable administrator web application 115 through which the experiential marketing platform 110 may manage the experiential marketing system.

The administrator web application 115 may include many different functionalities, including one or more of the following:
An “administrator login view state” includes a login and “forgot password” wizard for designated administrators.
An “administrator interests view state” includes search, sort, filter, and export functionality to enable table management of experiential elements (i.e., interests). The “administrator interests view state” also allows for the creation of an experiential element by the administrator, the viewing of interest profiles, and the taking of management actions such as making an experiential element active or inactive, or adding or deleting an experiential element.
An “administrator brands view state” allows for the addition or deletion of clients (i.e., brands) into the application, the viewing of brand profiles, and the managing of actions such as adding events, matching consumers, viewing productivity results, etc.
An “administrator event view state” includes an event creation wizard, event profile manager, and a consumer matching preview. This view state also allows the administrator to assign a venue to a created event, and allows for event profile management actions such as custom push notifications to attendees, rescheduling of events, event location management, etc.
An “administrator calendar view state” offers a calendar view of multiple brand aggregation, i.e., showing what events are happening at what time throughout system.
An “administrator user view state” lists all consumers and their profiles, and allows for limited profile management actions (e.g., e-mails to reset password, edit limited information, etc.) This view state also allows for management of notes on consumers, which may be shared among administrators.
An “administrator dashboard view state” organizes consumer activity on the system by geographic location and allows for the compilation of related statistics, such as consumer productivity on various social media sites, upcoming events, estimations of consumer attendance, and other system metrics, such as capacity of servers, number of consumers online at any given period, load balancing, etc.
An “administrator subpages view state” includes information and listings relating to each administrator, their profile, and management actions relating thereto (i.e., resetting password, uploading photos, etc.) This view state further allows for the creation of new administrators or sub-administrators, including allowing or restricting system access, etc. This view state also includes a listing of all push notifications on the system and all details relating thereto, including how many consumers received and opened notifications. Additional functionality includes an ad hoc push notification creation wizard which allows for the ability to send mass notifications on demand based on parameters such as event type, brand, geography, etc.
An “administrator reporting view state” allows for report generation. Reports may include “pre-event consumer matching” reports (based on consumer demographics and filtered by experiential element and interests), “event attendance by consumer demographics” reports (detailing the effectiveness of an event with respect to consumer attendance), “post-event user productivity by platform engagement” reports (detailing, per event, what each user did on each social media platform and the amount of engagement received on each platform), general user reports (user growth and status by date and time), “general brand success” reports (showing aggregate data, by brand, relating to engagement, sharing, and attendance for one or more events over various dates and times), and general event reports.

In addition to the foregoing functionality, the experiential marketing platform 110 may further include the following backend framework modules, services, and stand-alone solutions to enhance the system functionality:
SMS support;
Front and back-end push notification modules to enable the sending of push notifications to consumer devices on the back-end and receive them on the front end;
Email notification module;
PDF generation module which allows consumers to download tickets and other images pdf format;
Social media integration which allows the platform to monitor and pull in consumer data based on consumer posts on social media (e.g., Facebook, Pinterest, Instagram, Twitter, etc.);
Language localization;
Various algorithms to measure user productivity, user desirability, user influence, user interest suggestions, and brand interest suggestions;
Various algorithms to match specific consumers with specific brands;
Various algorithms to match specific consumers and/or specific brands to specific events;
LexisNexis FlexID and Q/A verification module;
Event break integration which matches events to existing events, and publishes new events that are pushed out for each brand;
Geolocation radius, boundaries, and monitoring modules which allows for push notifications when consumers enter those radii or boundaries;
Back-end gamification module development;
Note module development;
Message notification (including emails scripting relating to consumer registration, forgot password queries, administration registrations, event invites, post-event responsibilities, event invite push messages, brand invite push messages, starting event push messages, post-event push messages); and/or
Asset designs (public designs, interest & icon designs, badges and levels designs, mobile graphics, etc.)

Additional framework may include middleware API, permissions and statuses, file management (for the management of pictures and other files), error logging and handling, trackback referral source (showing locations of consumers and how they are reaching the application), cognitive services (automatically recognizing profanity or inappropriate content), and translation services.

While certain general framework components and functionality have been described herein, the present disclosure is not to be so limited. As understood in the art, various components and functionality may be integrated with and/or modified in the system without departing from the spirit and scope of the present disclosure.

In sum, the improved experiential marketing system and method disclosed herein transforms live events into the ultimate mixed physical and digital marketing channel for the experience economy. Clients select the exact consumers they wish to engage in the specific way those consumers desire to be engaged. The system further provides brand-directed, consumer-incentivized content that may be disseminated for social media consumption. The result is trusted digital content for brands and valuable live experiences for consumers.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method for experiential marketing comprising:
registering a plurality of consumers through a registration interface;
receiving said consumers' authorization to collect digital information on the consumer from a social network or personal data aggregation service;
receiving demographic information about said consumers through a demographic interface;
storing said consumers' digital information and demographic information in an electronic data base;
making said consumers' digital information and demographic information available for anonymous view and manipulation through a client experience interface;
manipulating the information to create subsets of said consumers through a personal interface;
providing a ranking of experience elements for a client to select for a subset of consumers through said client experience interface;
selecting an event for said selected subset of said consumers;
notifying said selected subset of said consumers of an event produced by said client, whereby access to said event is limited to said selected subset of said consumers;
utilizing a task interface to send at least three messages to mobile devices used by said selected subset of said consumers attending said event, wherein said messages are sent before, during and after said event, and instruct said selected subset of said consumers attending said event to post content related to said event on a social network;
identifying content posted to social networks by said selected subset of said consumers attending said event; and
proving said client access to information regarding said content.
